(19) United States
(12) Patent Application Publication
(10) Pub. No.: US 2008/0091496 A1
(43) Pub. Date: Apr. 17, 2008

(54) METHOD AND SYSTEM FOR DELIVERING AND EXECUTING BEST PRACTICES IN OILFIELD DEVELOPMENT PROJECTS

(76) Inventors: Omer Gurpinar, Greenwood Village, CO (US); Murli Challappa, Sugar Land, TX (US); Blaine Hollinger, Calgary (CA); Bulent Balci, London (GB)

Correspondence Address: SCHLUMBERGER INFORMATION SOLUTIONS, 5599 SAN FELIPE, SUITE 1700, HOUSTON, TX, 77056-2722, US

(21) Appl. No.: 11/694,986

(22) Filed: Mar. 31, 2007

Related U.S. Application Data
(60) Provisional application No. 60/852,503, filed on Oct. 17, 2006.

(51) Int. Cl. G06Q 10/00

(52) U.S. Cl. 705/8

(57) ABSTRACT

Oilfield development project planning and execution framework is disclosed for delivering and implementing expert knowledge and best practices in oilfield development projects. Such a project planning and execution framework integrates relevant expert knowledge and best practices with project planning and execution to guide a multi-discipline project team in successfully designing and conducting an oilfield development project. In preferred embodiments, the project planning and execution framework is a web-based tool that may be accessed by different users across multiple geographical locations and business units.

### CROSS-REFERENCE TO RELATED APPLICATIONS

This application for patent claims priority to, and hereby incorporates by reference, U.S. Provisional Application Ser. No. 60/852,503, entitled “Method, Apparatus and System for Delivering and Executing Best Practices in Oilfield Development Projects,” filed Oct. 17, 2006, with the United States Patent and Trademark Office.

### BACKGROUND OF THE INVENTION

1. Oilfield of the Invention

This invention relates to methods and systems for use in oilfield development projects. In particular, the invention provides methods and systems for more effectively and efficiently delivering and executing expert knowledge and best practices in oilfield development projects.

2. Background of the Invention

Oilfield development projects involve interpretation and integration by a large team with expertise in multiple disciplines (e.g., geophysics, engineering, economics, etc.). Such oilfield development projects often require iterative work in a collaborative environment, sometimes distributed globally. Completing the oilfield development projects in an optimum amount of time and providing a reliable outcome demands a project planning and execution environment in which design, resource allocation, knowledge management, and execution are all done in an integrated manner.

Historically, oilfield development projects were conducted according to project design and execution documents created by individual engineering teams handling specific tasks. Over time, a tremendous amount of expert knowledge and best practices have been accumulated through these documents. It would be useful to be able to apply such expert knowledge and best practices to new and on-going development projects. However, there is currently no way to systematically deliver and implement (i.e., put into practice) the expert knowledge and best practices to users. In addition, there is currently no reliable, integrated project management environment that can be accessed globally for managing the oilfield development projects. Consequently, the quality and reliability of oilfield development project planning and execution has heretofore varied from project to project.

Accordingly, despite recent advances, there is a need for an integrated planning and executing process in oilfield development projects. In particular, there is a need for a globally accessible planning and executing process that is capable of delivering and implementing relevant expert knowledge and best practices in such oilfield development projects.

### SUMMARY OF THE INVENTION

The present invention provides a project planning and execution framework for delivering and implementing expert knowledge and best practices in oilfield development projects. Such a project planning and execution framework integrates relevant expert knowledge and best practices with project planning and execution to guide a multi-discipline project team in successfully designing and conducting an oilfield development project. In preferred embodiments, the project planning and execution framework is a web-based tool that may be accessed by different users across multiple geographical locations and business units.

In general, in one aspect, the invention is directed to a computer-based method for planning and conducting an oilfield development project. The method comprises determining an optimal set of project elements for the oilfield development project based on expert knowledge and/or best practices identified from previous oilfield development projects and linking specific expert knowledge and/or specific best practices with specific project elements. The method further comprises presenting the project elements in an integrated project planning and execution environment and allowing a user to plan and execute the project elements using the integrated project planning and execution environment, the integrated project planning and execution environment enforcing compliance by the user with certain ones of the expert knowledge and/or the best practices.

In general, in one aspect, the invention is directed to a computer-based system for planning and conducting an oilfield development project. The system comprises at least one subsystem configured to determine an optimal set of project elements for the oilfield development project based on expert knowledge and/or best practices identified from previous oilfield development projects and at least one subsystem configured to link specific expert knowledge and/or specific best practices with specific project elements. The system further comprises at least one subsystem configured to present the project elements in an integrated project planning and execution environment and at least one subsystem configured to allow a user to plan and execute the project elements using the integrated project planning and execution environment, the integrated project planning and execution environment enforcing compliance by the user with certain ones of the expert knowledge and/or the best practices.

In general, in yet another aspect, the invention is directed to a computer-readable storage medium having computer-readable instructions encoded thereon for causing a computer to provide an integrated oilfield development project planning and execution environment. The computer-readable instructions comprise instructions for presenting a set of project elements for an oilfield development project in the integrated oilfield development project planning and execution environment, the set of project elements derived based on expert knowledge and/or best practices identified from previous oilfield development projects. The computer-readable instructions further comprise instructions for allowing a user to plan and execute the project elements using the integrated oilfield development project planning and execution environment, the integrated oilfield development project planning and execution environment enforcing compliance by the user with certain ones of the expert knowledge and/or the best practices.

In general, in still another aspect, the invention is directed to an article of manufacture for use in planning and executing an oilfield development project. The article comprises a processor and computer-readable storage medium connected to the processor. The computer-readable storage medium has computer-readable instructions encoded thereon for causing the processor to store an optimal set of project elements for the oilfield development project, the project elements based on expert knowledge and/or best practices identified from previous oilfield development projects. The computer-readable storage medium additionally has computer-readable instructions encoded thereon for causing the processor to link specific expert knowledge and/or specific best practices with specific project elements and present the project elements in an integrated project planning and execution environment. The computer-readable storage medium further has computer-readable instructions encoded thereon for causing the processor to allow a user to plan and execute the project elements using the integrated project planning and execution environment, the integrated project planning and execution environment enforcing compliance by the user with certain ones of the expert knowledge and/or the best practices.

Other objects, features and advantages of the present invention will become apparent to those of skill in art by reference to the figures, the description that follows and the claims.

### BRIEF DESCRIPTION OF THE DRAWINGS

FIG. 1 illustrates an example of an oilfield that may be developed using preferred embodiment of the inventions;

FIG. 2 illustrates a portion of a wellbore operation, such as the wellbore operation shown in FIG. 1;

FIG. 3 illustrates an exemplary oilfield development project planning and execution system according to a preferred embodiment of the invention;

FIG. 4 illustrates an exemplary oilfield development project planning and execution server according to a preferred embodiment of the invention;

FIG. 5 illustrates an exemplary oilfield development project planning tool according to a preferred embodiment of the invention;

FIGS. 6A-6B illustrate an exemplary start page for the oilfield development project planning and execution tool according to a preferred embodiment of the invention;

FIG. 7 illustrates an exemplary overview page for the oilfield development project planning and execution tool according to a preferred embodiment of the invention;

FIG. 8 illustrates an exemplary project team page for the oilfield development project planning and execution tool according to a preferred embodiment of the invention;

FIG. 9 illustrates an exemplary documents page for the oilfield development project planning and execution tool according to a preferred embodiment of the invention;

FIGS. 10A-10B illustrate an exemplary planning page for the oilfield development project planning and execution tool according to a preferred embodiment of the invention;

FIG. 11 illustrates an exemplary tasks page for the oilfield development project planning and execution tool according to a preferred embodiment of the invention;

FIG. 12 illustrates an exemplary action items page for the oilfield development project planning and execution tool according to a preferred embodiment of the invention;

FIG. 13 illustrates an exemplary risk assessment page for the oilfield development project planning and execution tool according to a preferred embodiment of the invention;

FIG. 14 illustrates an exemplary process page for the oilfield development project planning and execution tool according to a preferred embodiment of the invention;

FIG. 15 illustrates an exemplary details page for the oilfield development project planning and execution tool according to a preferred embodiment of the invention;

FIG. 16 illustrates an exemplary checklist page for the oilfield development project planning and execution tool according to a preferred embodiment of the invention;

FIG. 17 illustrates an exemplary and other details page for the oilfield development project planning and execution tool according to a preferred embodiment of the invention;

FIG. 18 illustrates an exemplary another process page for the oilfield development project planning and execution tool according to a preferred embodiment of the invention; and

FIG. 19 illustrates a method of implementing an oilfield development project planning and execution tool according to a preferred embodiment of the invention.

### DETAILED DESCRIPTION OF THE DRAWINGS

Following is a detailed description of preferred embodiments and other embodiments of the invention, with reference to the accompanying drawings. Those of skill in the art will readily see, however, that other embodiments and changes may be made without departing from the scope of the invention.

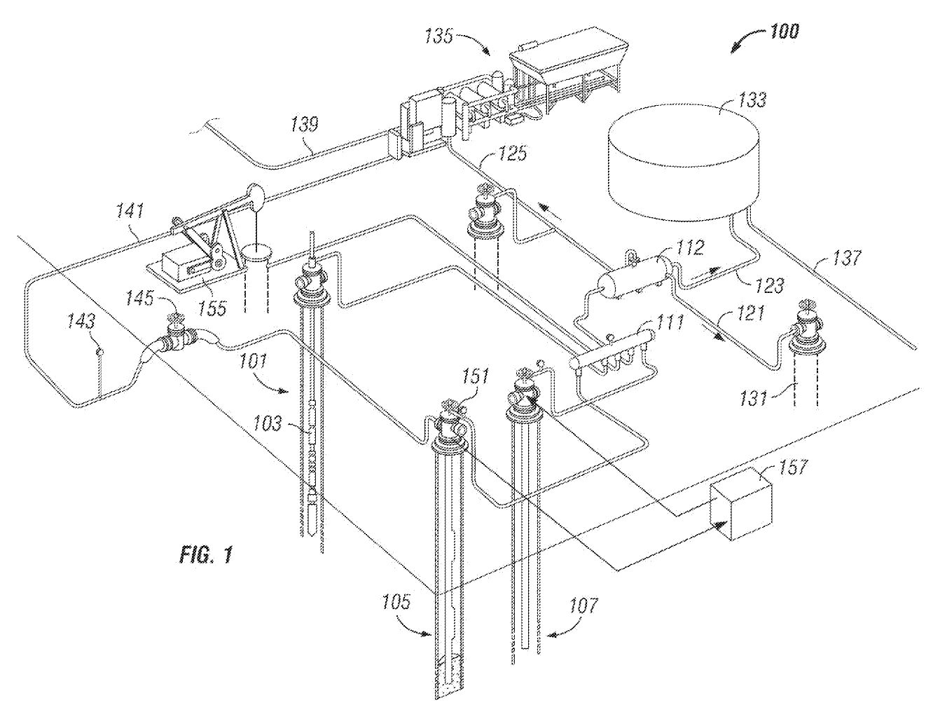

Referring now to FIG. 1, development of an oilfield 100 is depicted having machinery used to extract hydrocarbons (e.g., oil, gas, etc.) from downhole formations. An operations control center 157 may assist in collecting data and making decisions to enhance operations in the oilfield. Data such as measurements of bottom hole pressure and tubing head pressure may be gathered from the oilfield and analyzed.

As shown in FIG. 1, the oilfield 100 includes a number of wells. Specifically, the oilfield 100 includes a first producing well 101 that uses an electric submersible pump 103 to produce a hydrocarbon (e.g., oil, gas, etc.), a second well 105 relies on a gas lift to produce a hydrocarbon, and a third well 107 that relies on natural flow to produce a hydrocarbon. First producing well 101, second well 105, and third well 107 deliver production fluids (e.g., hydrocarbon) produced from their respective wells to a production manifold 111. The production manifold 111 collects multiple streams and outputs the streams to a gas and oil separator 112.

Upon receipt of the production fluids by the gas and oil separator 112, the gas and oil separator 112 separates various components from the fluids, such as produced water 121, produced oil 123, and produced gas 125, respectively to water disposal well 131, oil storage 133, and a compressor station 135. Oil storage 133 may transfer oil via an oil export pipeline 137. Similarly, the compressor station 135 may use gas export pipeline 139 to transfer gas. Finally, the compressor station 135 may process gas as an injection gas 141.

In order to adjust pressure on the injection gas, a meter and control system 143 may cooperate with an injection-gas manifold 145. The operation of the meter and control system 143 may regulate pressure of the injection gas as the injection gas is delivered to a wellhead tubing and casing 151. In addition to the injection gas, extracting efforts may rely upon a rod pump 155 to drive a downhole pump assembly via a reciprocating motion. In such cases, the rod pump 155 propels hydrocarbons to the production manifold 111.

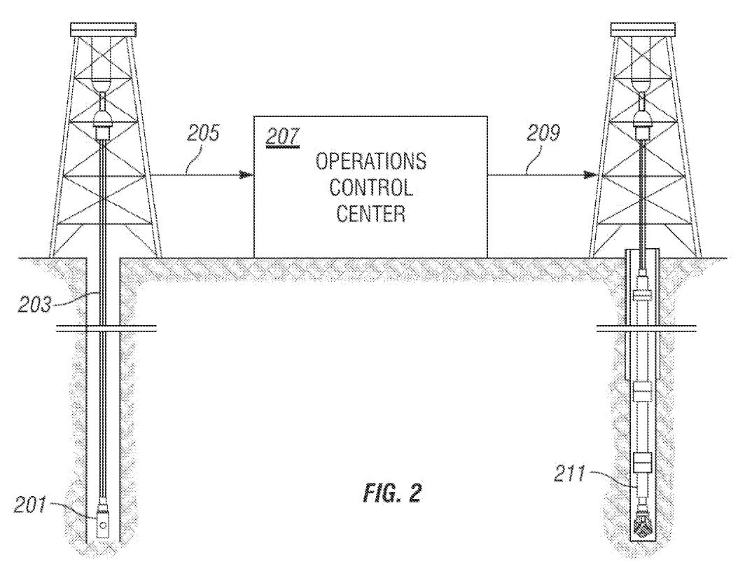

In one example, the operations control center 157 may receive data from sensors positioned throughout the oilfield 100. Examples of sensors are depicted and described in further detail with respect to FIG. 2 and described further below. The operations control center 157 may also operate and/or control equipment in the third well 107.

FIG. 2 shows a portion of a wellbore operation, such as the wellbore operation of FIG. 1, in greater detail. This diagram depicts the cooperation of an operations control center 207 with at least two wells. As discussed above, one purpose of the operations control center 207 is to collect data and control a drilling operation. Down-hole sensors 201 and well-head sensors 203 provide data (i.e., data collected and/or otherwise obtained from the down-hole sensors 201 and/or the well-head sensors 203). Upon receipt of the data, a first communication link 205 transfers the aforementioned data to the operations control center 207. Data may also be collected from other sources, and/or sent to other sites not depicted. Such data may be historical, real time, or stored data.

The operations control center 207 stores and, in some cases, optionally processes and/or analyzes the data. In some cases, the operations control center 207 may also generate and transmit control signals via a second communication link 209 to a down-hole apparatus 211. For example, the operations control center 207 may automatically generate control signals using data obtained via the first communications link 205. In another example, the operations control center 207 may provide information to an operator that may consider the information, and then send control signals as desired. In addition, the operations control center 207 may also provide feedback to the down-hole sensors 201 and/or three well-head sensors 203 using data obtained via the first communications link 205.

As may be readily seen from the above, oilfield development projects are extremely complicated and complex endeavors that require a multi-discipline team to design and execute. Over time, a large body of expert knowledge and best practices have been developed from past successful completion of such oilfield development projects. It would be useful to be able to apply this body of expert knowledge and best practices to both new and existing oilfield development projects. Currently, the expert knowledge and best practices are captured in documents that are made available through databases and information-sharing portals. However, there is no way to systematically and deliver and facilitate implementation of selective, task-specific expert knowledge and best practices by project personnel. In addition, there is no reliable, integrated project management environment that may be used by the project personnel for managing the oilfield development projects.

Embodiments of the invention provide a project planning and execution tool that overcomes the drawbacks and shortcomings of existing solutions. The project planning and execution tool basically provides a framework for systematically delivering and implementing existing expert knowledge and best practices. Such an arrangement helps oilfield development project personnel produce a consistent oilfield development product. The expert knowledge and best practices that may be delivered include, for example, an array of task specific workflows that guide the users in detail from data input requirements through recommended software application usage and ultimately to task-specific deliverables. The project planning and execution tool may be used to carry out existing oilfield development planning and execution processes as well as new processes that are developed over time. In a preferred embodiment, the project planning and execution tool is a Web-based tool that may be accessed by project personnel at any geographical location and/or business unit.

In general, the project planning and execution tool may be used to guide a multi-discipline project team to successfully design and carry out an oilfield development project by integrating knowledge management and project execution. In preferred embodiments, the project planning and execution tool provides a standardized project workflow template accessible for monitoring and updating purposes directly through the tool. In addition, the project planning and execution tool assists in project planning through scope management, task scheduling, cost analysis, resource allocation, risk assessment and contract finalization. Improved quality and effectiveness of peer reviews are achieved through the project planning and execution tool, as well as automating and streamlining of internal and/or external procedures. The project planning and execution tool may also be used to support centralized database storage of all oilfield development projects, including making the databases available to assist with future oilfield development projects. Workflow support through every level of the oilfield development process may be provided, including detailed task recommendations via direct access to relevant process document material, lessons learned (preferably through knowledge-sharing portals), best practices (preferably via live links to databases), and oilfield development project tasks, captured database tips and history. Other benefits of the project planning and execution tool include a mechanism to track efficiencies and identify process improvements for users.

In some preferred embodiments, the project planning and execution tool is designed to follow existing project approval procedures. The procedures may be refined and designed within the project planning and execution tool so as to be automatically adhered to by personnel for each project, thus ensuring consistency and accountability for all oilfield development planning projects performed. The combination of expert knowledge and best practices gained through previous endeavors plus the automated project management features built specifically around the knowledge and best practices provide significant advantages over existing solutions.

Furthermore, all technical peer review requirements and operational review requirements may be made available to all involved personnel throughout the life of the oilfield development project in a preferred embodiment of the invention. This helps ensure that each project benefits from the knowledge gained from previous studies, and allows the project planning and execution tool to serve as a network for tracking efficiencies and process improvements.

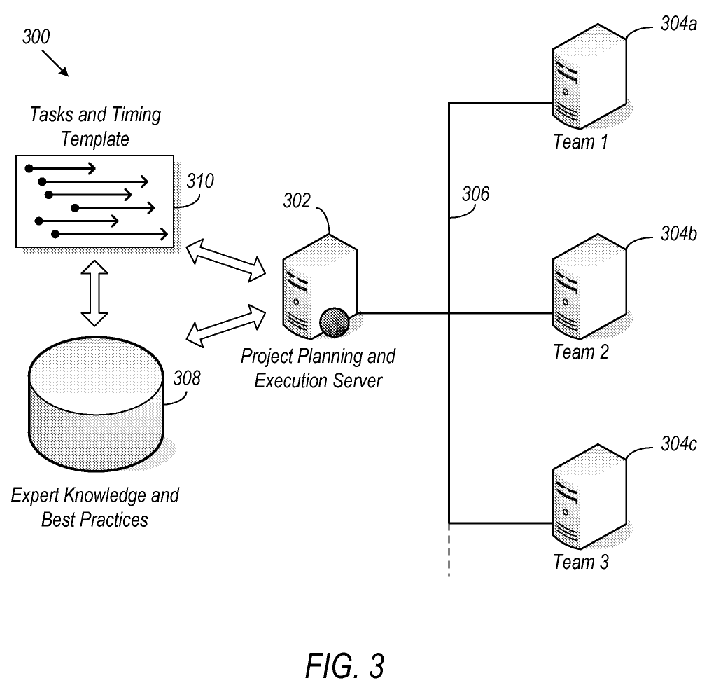

Referring now to FIG. 3, an exemplary project planning and execution system 300 is shown according to a preferred embodiment of the invention. As may be seen, the project planning and execution system 300 includes at least one project planning and execution server 302 from which one or more oilfield development projects may be planned and managed on a global basis. Oilfield development project teams 304a, 304b, and 304c (e.g., Teams 1-3, etc.) in different geographical locations and/or business units may then connect to the at least one project planning and execution server 302 and access the various projects thereon. Members of the teams 304a-c may then view various tasks for a given project, access any expert knowledge and best practices associated with each task, update and/or complete the tasks, assign and/or create new tasks, request peer review and approval for certain tasks, and the like. The connection to the at least one server 302 may be accomplished using any suitable wired and/or wireless connection 306 to a global network, such as the Internet and the World Wide Web (the “Web”). In the latter case, the project planning and execution server 302 may be a Web server that is capable of hosting one or more Web pages.

In accordance with preferred embodiments of the invention, one or more repositories 308 of expert knowledge and best practices are connected to the project planning and execution server 302. Such repositories 308 may take any suitable form, including information databases, knowledge-sharing portals, industry association Web sites, and the like, and may be implemented using, for example, Microsoft SharePoint Server™, and the like. The repositories 308 contain expert knowledge and best practices that have been accumulated over time for numerous successfully completed oilfield development projects as well as lessons learned from less successful projects. Because the volume of information in these repositories 308 can be quite large (e.g., hundreds of pages), oilfield development project personnel may be reluctant to make use of the information. To this end, the project planning and execution server 302 organizes, arranges, and delivers selective, task-specific information in a form that is simple and convenient for the oilfield development personnel to use.

The expert knowledge and best practices may also be used to define a core set of tasks that needs to be performed in an oilfield development project and the timing for each task. Such tasks and timing may be defined, for example, using Microsoft Project Server™, and the like. These tasks and timing may then be stored as a sort of template 310 that is provided to the project planning and execution server 302 for use with all subsequent oilfield development projects. As with the expert knowledge and best practices information, the project planning and execution server 302 organizes, arranges, and delivers the tasks and timing information in a form that is easy and convenient for the oilfield development personnel to use.

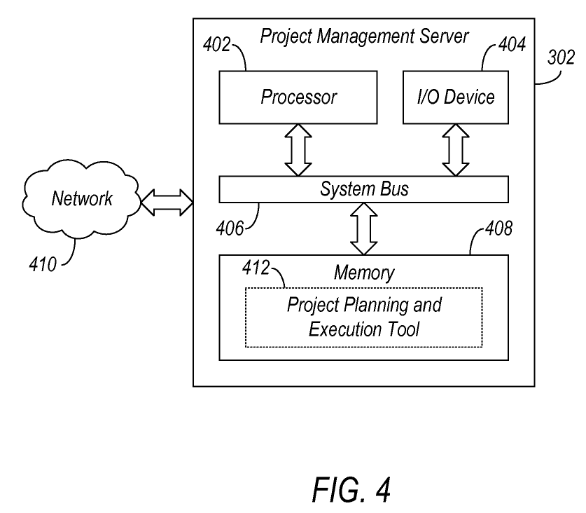

FIG. 4 illustrates an example of the at least one project planning and execution server 302 (see FIG. 3) in more detail. As may be seen, the project planning and execution server 302 may be, among other things, a personal computer (PC), a server (e.g., a Web server), a workstation (e.g., a Sun Microsystems workstation), two or more networked workstations, a mainframe computer, and the like. In the example shown, the project planning and execution server 302 has a number of functional components, including at least one processor 402, an input/output (I/O) unit 404, a system bus 406, and a computer-readable memory 408. A network 410 connects the project planning and execution server 302 to other networks, systems, databases, computers, and the like. These components of the project planning and execution server 302 are generally well known to those having ordinary skill in the art and therefore will not be described in great detail here. Furthermore, although multiple discrete components are shown in FIG. 4, those having ordinary skill in the art will understand that two or more of these components may be combined into a single component, and that a single component may be divided into several sub-components, as needed.

Briefly, the processor 402 is responsible for the overall operation of the project planning and execution server 302, including executing of the operating system software and any other software applications that may be present on the project planning and execution server 302. The I/O unit 404 controls the flow of data into and out of the project planning and execution server 302, for example, through various media reader devices and output devices. The system bus 406 allows the various functional components of the project planning and execution server 302 to communicate and exchange data with one another. The computer-readable memory 408, which may be a magnetic, optical, and/or semiconductor memory, provides temporary and long-term storage for any information or data needed by the operating system and applications running on the project planning and execution server 302. Finally, the network 410 may be an Ethernet-based wired and/or wireless network for connecting the project planning and execution server 302 to other networks, systems, databases, and the like.

In accordance with preferred embodiments, a project planning and execution tool 412 may be stored in the computer-readable memory 408. The project planning and execution tool 412 may then be executed by the processor 402 and/or other components for delivering and implementing expert knowledge and best practices from the repositories 308 (see FIG. 3) to the oilfield development project personnel. More specifically, the project planning and execution tool 412 associates or otherwise makes available specific expert knowledge and best practices with each task to be performed in an oilfield development project. In addition, the project planning and execution tool 412 provides an integrated project management environment that may be used by such personnel for the overall planning and execution of the oilfield development projects, thereby ensuring consistent results from project to project. Indeed, in one sense, the project planning and execution tool 412 itself is a manifestation or implementation of the expert knowledge and best practices accumulated over time such that by simply using the project planning and execution tool 412, the oilfield development personnel is also using the expert knowledge and best practices.

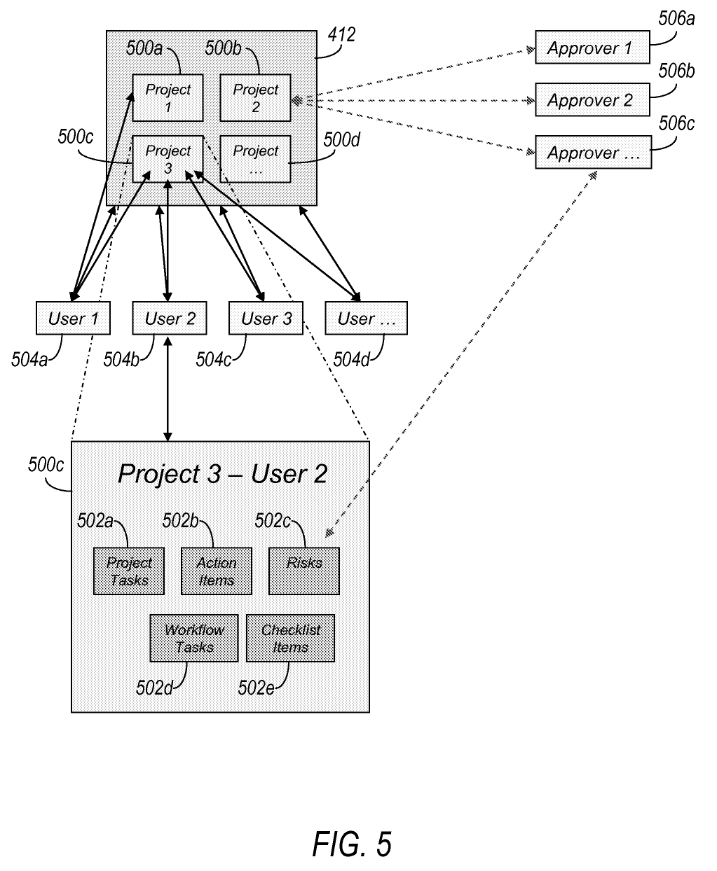

FIG. 5 illustrates operation of project planning and execution tool 412 in more detail. As may be seen, the project planning and execution tool 412 stores and maintains a plurality of oilfield development projects 500a, 500b, 500c, and 500d (i.e., Projects 1-3, etc.) on the at least one project planning and execution server 302. Typically, each oilfield development project 500a-e comprises a number of project actions, including numerous project tasks 502a to be performed, various action items 502b to be completed, risks 502c to be assessed, workflow tasks 502d to be monitored, and checklist entries 502d to be signed off. In general, project tasks are technical tasks to be followed from developed procedures and best practices to perform a technically proper field development plan. Workflow tasks, on the other hand, are approval tasks required in the overall process to ensure technical tasks have been honored according to procedures and best practices. These project actions 500a-e are shown in the expanded view (dashed lines) of the third oilfield development project 500c (i.e., Project 3). In one preferred embodiment, the project actions 500a-e (or the detailed information therefor) may be generated and stored using, for example, Microsoft Project Server™ and/or Microsoft SharePoint Server™, then linked to or otherwise made accessible through the project planning and execution tool 412.

In addition to the oilfield development projects 500a-e, each oilfield development project 500a-d also may have a plurality of users 504a, 504b, 504c, and 504d (i.e., Users 1-3, etc.) and a plurality of reviewers and/or approvers 506a, 506b, 506c, and 506d (i.e., Approvers 1-3, etc.) assigned thereto. These users 504a-d and approvers 506a-d are usually assigned by the project owners, team leaders, and/or other users 504a-d and approvers 506a-d via the project planning and execution tool 412. In some cases, the users 504a-d for some oilfield development projects 500a-d may also be approvers 506a-d (and vice versa) for the same oilfield development projects and/or for different oilfield development projects 500a-d. Once assigned, each user 504a-d and approver 506a-d may be given an appropriate level of authorization to access the project planning and execution tool 412 and the projects 500a-d to which he/she has been assigned.

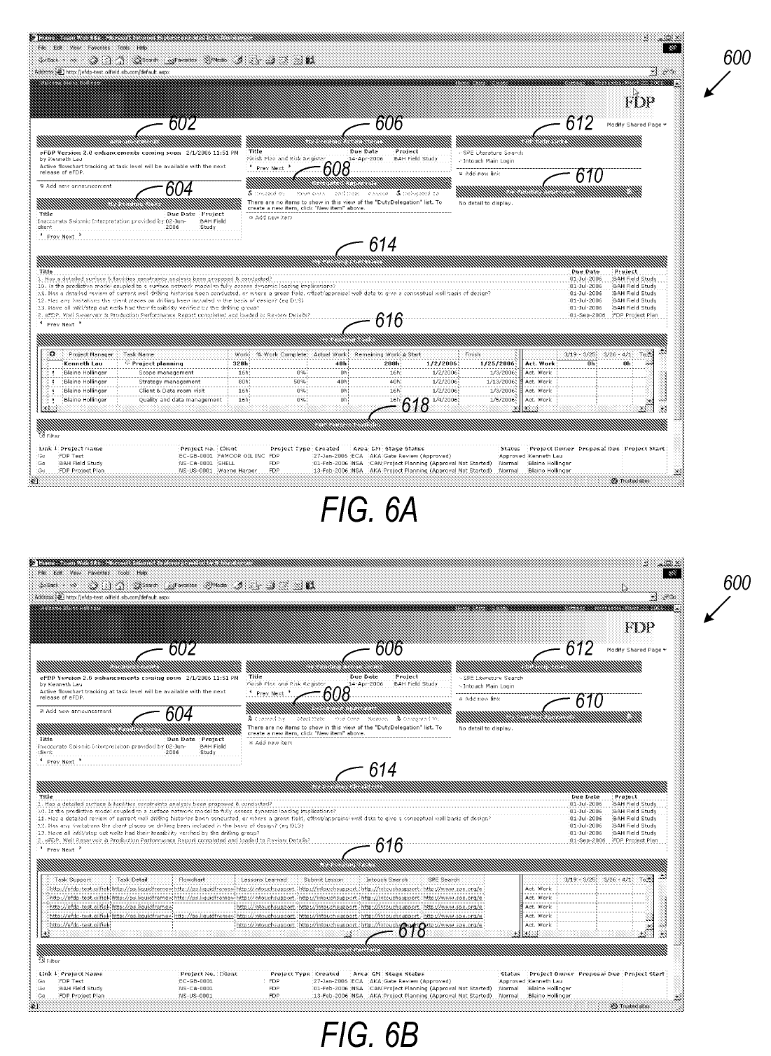

In one implementation, the project planning and execution tool 412 may be a Web-based tool that is accessible via any available Web browser. Such a Web-based tool may have a Web-based user interface composed of a plurality of Web pages. FIGS. 6A-6B, 7-9, 10A-10B, and 11-18 illustrate an exemplary set of Web pages that may be used for the Web-based user interface of the project planning and execution tool 412. It should be noted that, while specific colors, layouts, orientations and arrangements are shown for these Web pages, those having ordinary skill in the art will recognize that other colors, layouts, orientations and arrangements may be employed without departing from the scope of the invention. In addition, although a Web-based tool is shown and described, those having ordinary skill in the art will understand that other presentation formats may certainly be used without departing from the scope of the invention.

Referring first to FIGS. 6A-6B, when a user (e.g., project team member) logs into the project planning and execution tool 412 (e.g., by logging into his/her computer), he/she is presented with an individualized start page 600. The start page 600 shows all the tasks, actions items, risks, workflows, checklist entries, and so forth, for each oilfield development project in which the user is a project team member. Such a start page 600 provides the user with a single, centralized starting place from which he/she may directly discharge the responsibilities assigned to him/her. Because the assignments may vary from user to user, the start page 600 for one user may look quite different from the start page 600 for another user. To this end, the start page 600 in some embodiments may even allow one user to view the project actions for another user and/or other oilfield development projects in which the user is not a team member, depending on the particular setup of the start page 600.

In the particular implementation shown in FIGS. 6A-6B, the individualized start page 600 comprises a plurality of sections or areas, including an announcement area 602 for notifying the user of updates concerning the project planning and execution tool 412 (e.g., new version being released) and any other news or information. A pending risks area 604 displays a list of risk assessments the user has been assigned to conduct, and a pending actions area 606 displays a list of action items the user has been assigned to perform. As explained above, such risk assessments and/or action items (along with the timing therefor) are typically defined and stored ahead of time, for example, using Microsoft Project Server™, and the like. Relevant information, such as project names, due dates, a brief description, and the like, may also be displayed for each risk assessment and each action in their respective areas 604 and 606. The user may then retrieve specific details for these risk assessments and/or action items by selecting (i.e., by double-clicking) the desired project action.

Certain risk assessments, action items, and other project actions, in keeping with the expert knowledge and best practices, must undergo peer review and approval. To this end, the user may be asked by other users to review and approve one or more assessments, action items, or other project actions. These approval requests are typically displayed in the user's pending risk assessments area 604, pending actions area 606, and so forth. In the event the user is busy, absent, or feels unqualified, he/she may delegate the review and approval to another project team member. Such delegated approvals may then be displayed in a delegated approvals area 608, along with relevant information therefor (e.g., created by, start date, end date, brief description, reason for delegation, name of person delegated to, etc.). Approvals for the user's own project actions may be displayed in a pending approvals area 610, along with relevant information therefor (e.g., start date, end date, brief description, name of requester, etc.).

In addition to the above, in some embodiments, a help area 612 displays a list of internal and external information resources (e.g., industry literature, knowledge-sharing portals, etc.) that the user may access to find additional information for various aspects of the oilfield development project, a pending checklists area 614 displays a list of items that the user has been assigned to follow up on, and a pending tasks area 616 displays a list of tasks that the user has been assigned to perform. Relevant information (e.g., due date, project name, brief description, etc.) for each entry in the pending checklists area 614 and the pending tasks area 616, respectively, are also displayed. For the pending tasks area 616, such relevant information may also include the name of the project owner or manager, task name, hours associated with the task (e.g., total allocated, number worked, number remaining, etc.), start date, finish date, and the like.

In accordance with preferred embodiments of the invention, the pending tasks area 616 may further display hyperlinks to the relevant expert knowledge and best practices for each task. This can be more clearly seen in FIG. 6B (which is a continuation to the right of the pending tasks area 616 in FIG. 6A), where one or more expert knowledge and best practice hyperlinks are presented for each task. In some embodiments, such hyperlinks may include links for obtaining task support, task detail, flowchart, lessons learned, and the like, as well as hyperlinks for searching relevant databases and industry literature. The various hyperlinks are typically defined ahead of time for a given task using the expert knowledge and best practices that are most relevant for successfully performing that task. In this way, the user has the most useful information conveniently at hand for completing each task and need not wade through volumes of information searching for the proper procedures, guidelines, rules, and the like.

When selected, the hyperlinks take the user to a database and/or knowledge-sharing portal where the relevant expert knowledge and best practice information may be found for each task. As explained earlier, such expert knowledge and best practice information may be provided, for example, using Microsoft SharePoint Server™, and the like. This arrangement ensures that the relevant expert knowledge and best practices are systematically delivered or otherwise made accessible to the user to thereby facilitate implementation of such expert knowledge and best practices. In addition, in some preferred embodiments, the hyperlinks may also include links for submitting any lessons that were learned during the planning and execution of the oilfield development project. The lessons-learned may then be stored in the appropriate databases of the expert knowledge and best practice repositories 308 (see FIG. 3) for subsequent use in another oilfield development project.

A project portfolio area 618 displays all oilfield development projects for which the user is a team member, along with relevant information for each project (e.g., project name, project location, project type, project owner, client name, etc.). Selecting (i.e., by double-clicking) one of the oilfield development projects takes the user to a set of project pages that show all project actions and team members for that oilfield development project. Following now is a discussion of an exemplary set of project pages for one of the oilfield development projects, namely, the BAH Field Study project.

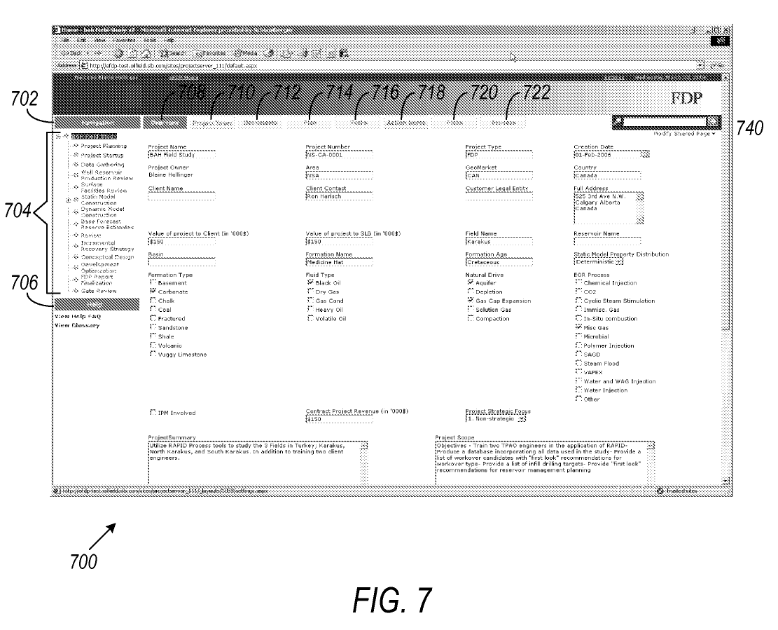

Referring to FIG. 7, for each oilfield development project, the project planning and execution tool 412 provides a series of Web-based project pages, starting with an overview page 700. In a preferred embodiment, each project page (such as the overview page 700) comprises a navigation section 702 that lists a plurality of stages 704 for the oilfield development project. The stages 704 represent different phases of the oilfield development project and have been organized and arranged in the project planning and execution tool 412 based on expert knowledge and best practices accumulated over time. Thus, the particular stages 704 presented and/or the arrangement thereof are preferably locked and may include, but are not limited to, project planning, project startup, data gathering, well reservoir production review, surface facilities review, static model construction, dynamic model construction, these forecasts reserve estimates, review, incremental recovery strategy, conceptual design, development optimization, report finalization, and gate review. In some embodiments, however, it may be desirable to allow the user to modify the particular stages 704 and/or the arrangement thereof.

Selecting one of the stages 704 brings up specific details and status information regarding that stage (as will be discussed further below). Although not expressly shown, a review and approval procedure is typically conducted after each stage, in keeping with existing expert knowledge and best practices. A help section 706 provides the user with access to additional information for various aspects of the oilfield development project. One or more tabs may be displayed across the top of each project page to allow the user to go directly to a particular project page. These tabs include, but are not limited to, an overview tab 708, a project team tab 710, a documents tab 712, a plan tab 714, a tasks tab 716, an action items tab 718, a risks tab 720, and a process tab 722.

The overview project page 700 is designed to give the user an overview of the oilfield development project. To this end, the overview project page 700 may include various basic information about the oilfield development project, such as identification information (e.g., project name, project owner, project number, project type, etc.). Other information may include geographical information (e.g., area, market, country, etc.) as well as client information (e.g., client name, client contact, client legal entity, client address, etc.). Still other information may include revenue information (e.g., value of project to client, the value of project to the service provider, contract revenue, etc.) and oilfield information (e.g., field name, reservoir name, basin name, formation name, etc.). The overview project page 700 may also provide geophysical information regarding the oilfield (e.g., formation age, formation type, fluid type, static model property distribution, natural drive, enhanced oil recovery process used, etc.). Finally, the overview project page 700 may provide high level information about the project, including whether a project requires an integrated project management focus, project strategic focus, project summary, project scope, and the like. The foregoing items of information are typically provided by the client or owner of the oilfield to the project manager, who may then manually key in the information or have it automatically imported into the project planning and execution tool 412.

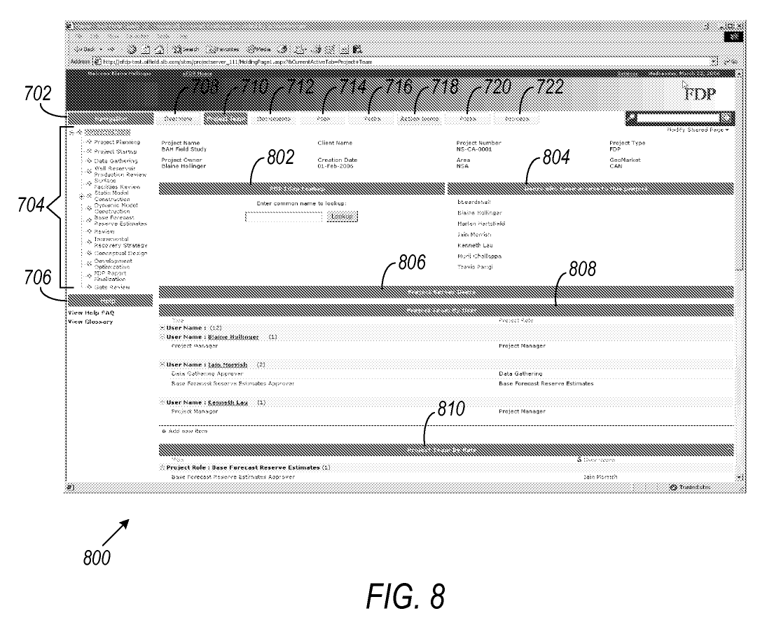

Selecting the project team tab 710 takes the user to a project team page 800, illustrated in FIG. 8, that displays information about the members of the oilfield development project team. In one preferred embodiment, the project team page 800 comprises a directory look-up area 802 for looking up information regarding company personnel. An authorized user area 804 lists all the members of the oilfield development project team and a project server users area 806 that displays all team members who are authorized to access the project planning and execution server 302 (see FIG. 3) and to use the project planning and execution tool 412 (see FIG. 4). These team members may be listed according to their user name (area 808) and/or according to their role (area 810) on the oilfield development project. Such a project team page 800 allows the user to know who the other team members are, which may be particularly helpful where the project is divided amongst multiple geographical locations and/or business units.

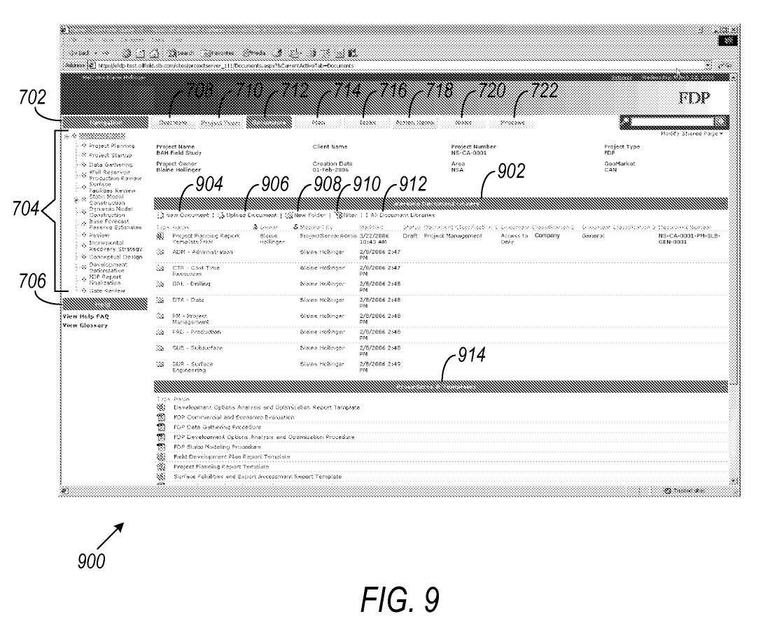

Selecting the documents tab 712 takes the user to a documents page 900, shown in FIG. 9, that displays a list of documents needed for the oilfield development project. In one preferred embodiment, the documents page 900 comprises a working document library area 902 that displays a list of documents being prepared in connection with the oilfield development project. Depending on the particular oilfield development project, such documents may include, for example, a project planning report, a cost, time, and resources report, a project management report, and the like, along with relevant information therefor (e.g., document owner, status, classification, document number, etc.). A plurality of buttons in the working document library area 902 provide various functionality with respect to the documents. These buttons may include, for example, a new document button 904 for creating new documents, and upload document button 906 for uploading documents to be project planning and execution server 302 (see FIG. 3), a new folder button 908 for creating new folders, and a filter button 910 for sorting the listed documents according to some criteria. An all document libraries button 912 displays a list of all document libraries, which is an all encompassing list of documents in the system. In addition to the above, a procedures and templates area 914 may be present on the documents page 900 for displaying a list of procedures and templates that may be used in the oilfield development project.

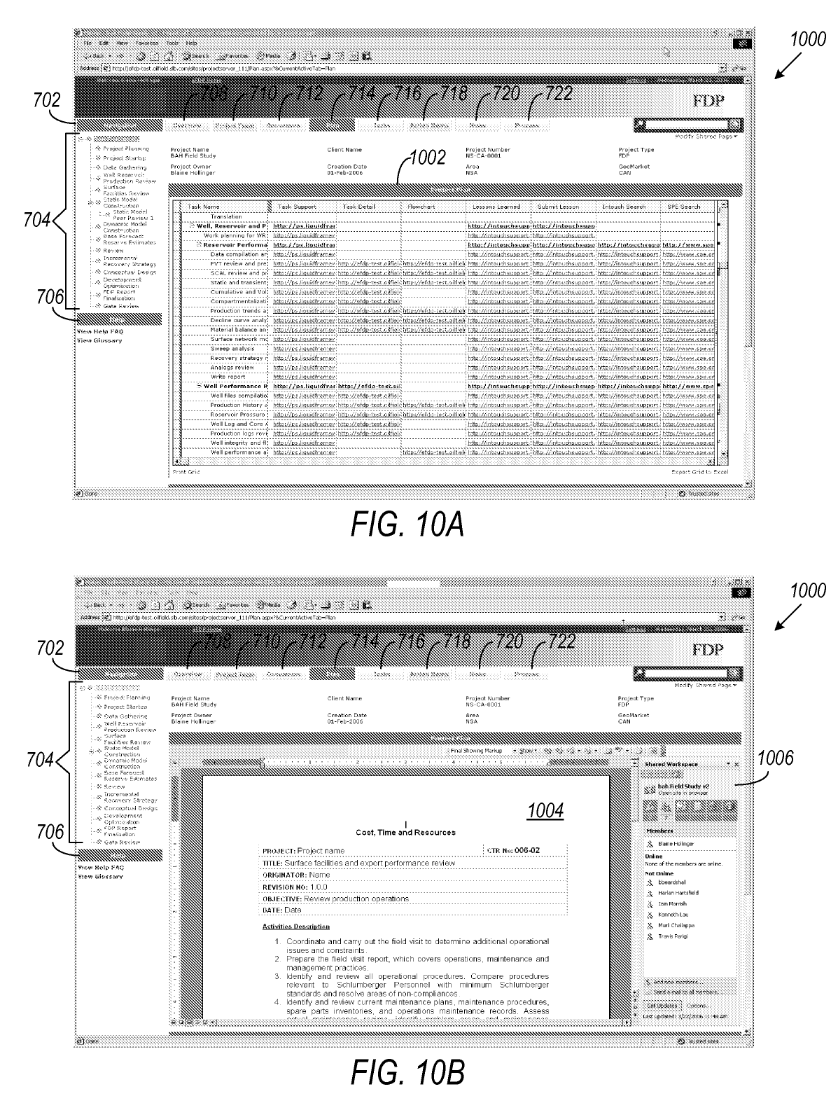

Selecting the plan tab 714 takes the user to a project plan page 1000, illustrated in FIGS. 10A-10B, that lets the user view the entire plan for the oilfield development project. As explained previously, such an oilfield development project plan may be defined using, for example, a Microsoft Project Server™ template (e.g., the tasks and timing template 310 of FIG. 3) derived from expert knowledge and best practices accumulated over time. In one preferred embodiment, the project plan page 1000 includes a project plan area 1002 for displaying a list of predefined hyperlinks for various components (e.g., Well Reservoir and Planning, etc.) and subcomponents (e.g., Reservoir Performance, etc.) of the oilfield development project plan. These hyperlinks provide the user with, for example, task support, task detail, flowchart, lessons learned (including submission of same), industry literature search, knowledge-sharing portal search, and other information relevant to successful completion of the component or subcomponent of the project plan. Selecting one of the hyperlinks brings up the appropriate document 1004 (see FIG. 10B) for that link, such as a procedures document, report template, technical specification, and the like.

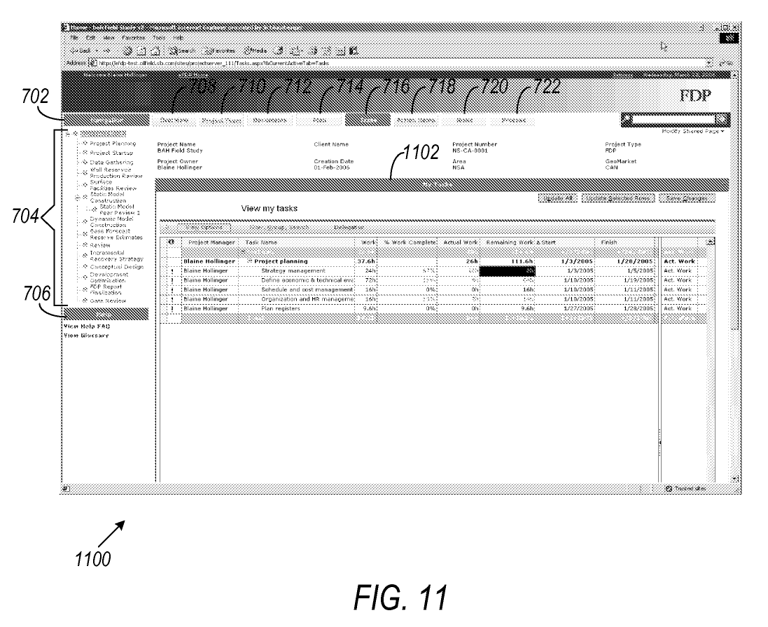

Selecting the tasks tab 716 takes the user to a tasks page 1100, shown in FIG. 11, that displays a list of the tasks that have been assigned to the user in this particular oilfield development project (i.e., the BAH Field Study project). These tasks, which are a subset of the tasks shown in the overview page 700 (see FIG. 7), may be displayed in a tasks area 1102 along with relevant information for each task, such as the number of hours allocated, hours worked, hours remaining, start date, finish date, and the like. The user may then view the details of a specific task, sort the tasks according to one or more criteria, delegate one or more tasks, and so forth, using Microsoft Project Server™ functionality, for example. From the tasks page 1100, the user may also modify and update the information for each task, such as entering the number of hours worked to date, requesting additional hours, and the like. This arrangement allows project managers and owners to monitor the number of hours being spent on the tasks by different team members and approve or deny any additional time allocation requested by these users.

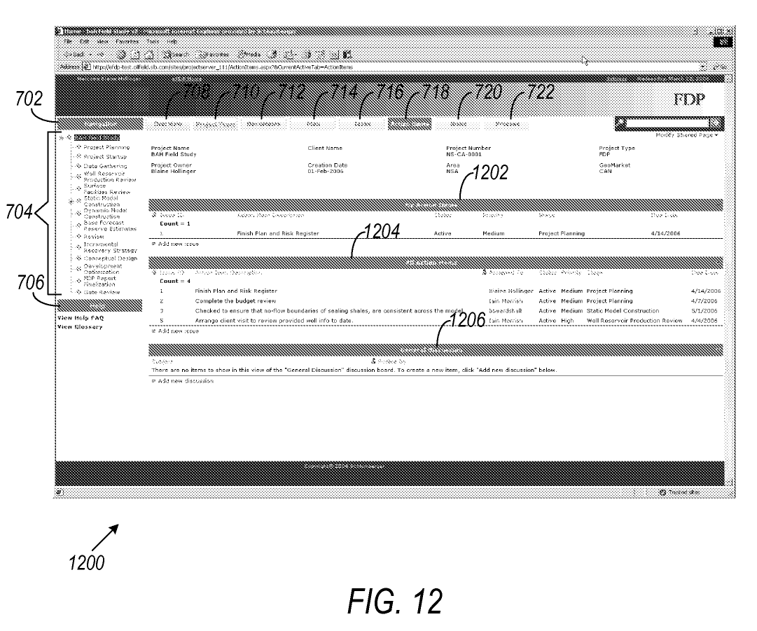

Selecting the action items tab 718 takes the user to an action items page 1200, illustrated in FIG. 12, where the user may view and track the action items for a particular oilfield development project. In one preferred embodiment, action items that are assigned specifically to the user may be displayed in one area 1202, while all action items generated in connection with the oilfield development project may be displayed in another area 1204, along with relevant information therefor (e.g., owner, status, priority level, due date, etc.). The user (typically the project manager or owner) may also generate new action items, update existing action items, delegate one or more action items, and the like, using Microsoft Project Server™ functionality, for example. A general discussion area 1206 provides a forum to discuss one or more action items and generate new discussions about a given action item.

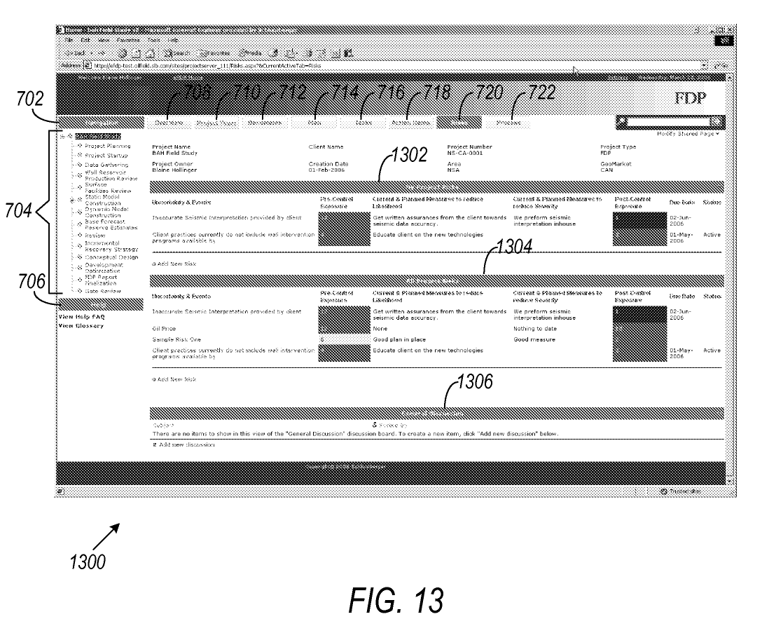

Selecting the risks tab 720 takes the user to a risks page 1300, shown in FIG. 13, where the user may view and track the risks identified for a particular oilfield development project. Risks assessments that are assigned specifically to the user may be displayed in one area 1302, while all risks assessments that have been requested in connection with the oilfield development project may be displayed in another area 1304. For all risk assessments, the risks page 1300 also displays the current and planned measures to reduce the likelihood of the risks being realized and the current and planned measures to reduce the severity of any consequences. The risks page 1300 also allows the user to categorize the severity of the risks (e.g., using a numeric scale) and the type or nature of the risks (e.g., using a color scheme) for pre- and post-control exposure. A general discussion area 1306 allows the user to participate in one or more group discussions about various risks and generate new discussions about a given risk.

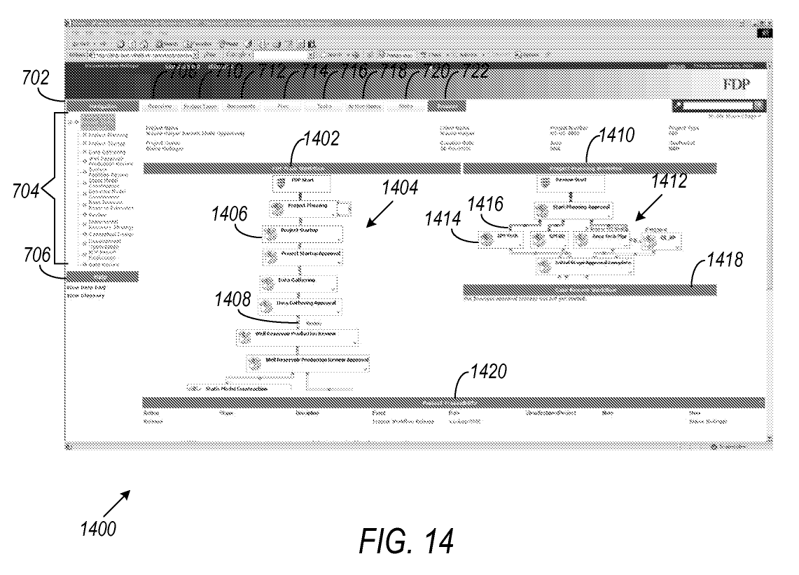

Selecting the process tab 722 takes the user to a process page 1400, shown in FIG. 14, where the user may view various workflows for a particular oilfield development project. In one preferred embodiment, a main workflow area 1402 displays a main workflow 1404 composed of a plurality of work steps 1406 that are connected to one another by workflow lines 1408. The work steps 1406 of the workflow 1404 generally mirror the stages 704 of the navigation area 702, except that the stages 704 do not expressly show the approval work steps. A secondary workflow area 1410 may be present for displaying a secondary workflow 1412 that contains the details for a corresponding work step 1406. Like the main workflow 1404, each secondary workflow 1412 is composed of a plurality of secondary work steps 1414 that are connected to one another by workflow lines 1416. In some embodiments, different colors may be used for displaying the work steps 1406, 1412 and/or workflow lines 1408, 1416 to indicate the statuses thereof (e.g., green for completed, red for in-process, white for not yet started, etc.). A gate review area 1418 displays a business approval workflow (not expressly shown) when present. The business approval workflow is an approval process that follows a similar path as the project planning workflow insofar as it requires similar approvals to sign off on a fully completed field development plan concluding the project. Finally, a general discussion area 1420 provides a forum for discussing any issues related to the various workflows and work steps.

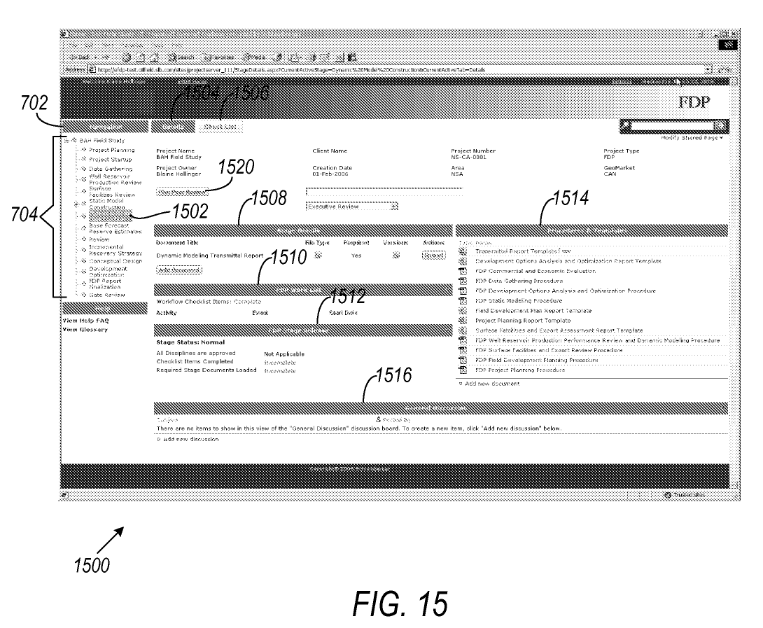

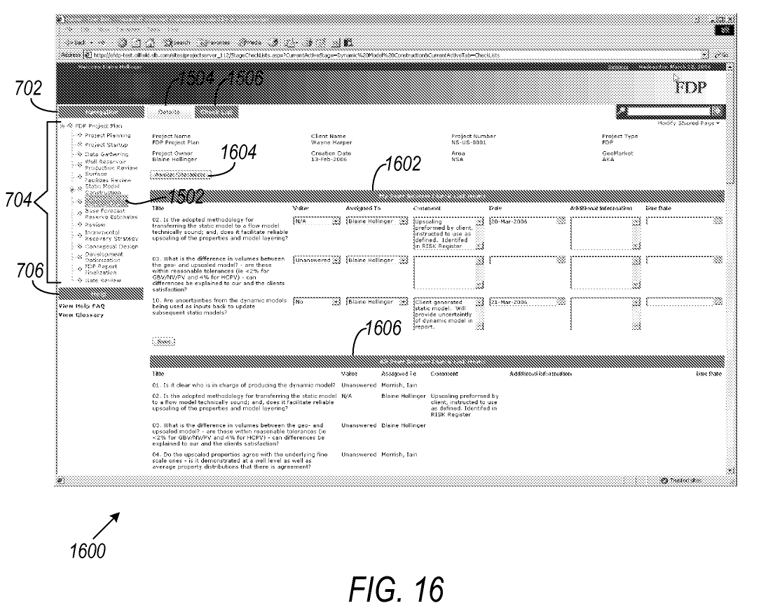

Recall that the stages 704, and thus the work steps 1406, represent different phases of the oilfield development project and have been organized and arranged within the project planning and execution tool 412 based on expert knowledge and best practices that have been accumulated over time. Selecting one of these stages 704 brings up stage-specific information that, in one preferred embodiment, is organized and presented in two Web pages, as shown in FIGS. 15-16.

Referring now to FIG. 15, the first of the two Web pages is a details page 1500 that identifies and lists various types of documents pertaining to the particular stage selected. The particular stage selected in this example is a dynamic model construction stage 1502. A details tab 1504 at the top of the details page 1500 allows the user to quickly select that page. Also present is a checklist tab 1506 for allowing the user to select a checklist page (described with respect to FIG. 16) for the particular stage 1502. In one preferred embodiment, the details page 1500 comprises a stage details area 1508 for displaying a list of documents to be prepared in connection with the oilfield development project, along with relevant information therefor (e.g., file type, version, whether the document is required, etc.). From the stage details area 1508, the user may also add new documents as well as upload documents to the project planning and execution server 302 (see FIG. 3). A work list area 1510 displays various workflow checklist items that are associated with the selected stage, along with relevant information therefor (e.g., activity, event, start date, etc.).

Also present is a stage release area 1512 for displaying the overall status of the stage 1502 (e.g., normal, ???, etc.) as well as specific aspects of the stage, such as whether all disciplines have been approved by the appropriate approvers, all checklist items are completed by the appropriate team members, all required stage documents have been uploaded, and the like. In one preferred embodiment, after all entries in the stage release area 1512 have been completed, the user may send an e-mail message (e.g., by selecting a “release for approval” button, not expressly shown) to the designated approvers for this particular stage 1502 with hyperlinks to all of the questions that have already been answered or addressed. The approvers may either approve the stage or have follow up further from that point. In this way, peer review of the various stages of the oilfield development project may be streamlined.

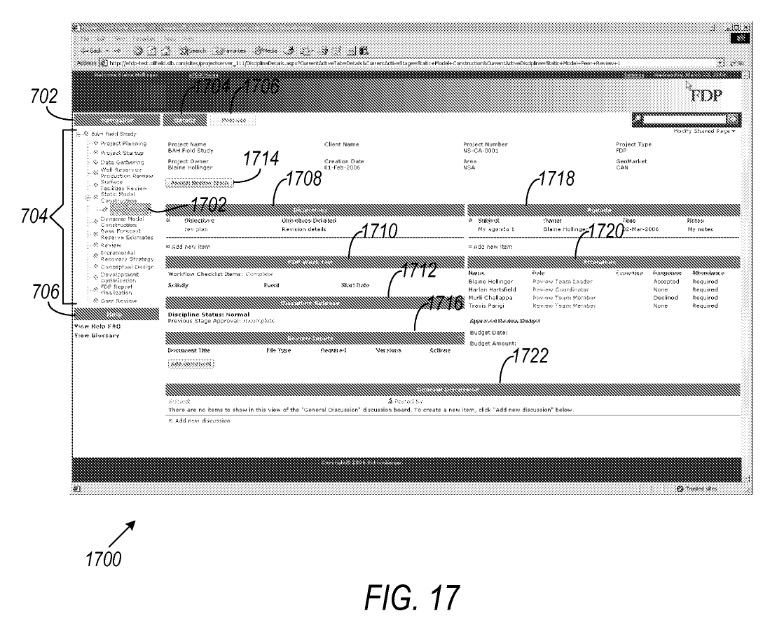

A procedures and templates area 1514 lists one or more procedure and/or template documents associated with the stage that the user may access, which documents are typically identified beforehand for a given stage. A group discussions relating to various topics may be conducted in a general discussion area 1516. Finally, a plan peer-reviewed button 1520 allows a user to plan a peer review agenda for a particular stage. This button basically creates a mid-stage/sub-stage peer review, as will be discussed further below in FIG. 17.

Selecting the checklist tab 1506 takes the user to a peer review checklist page 1600, illustrated in FIG. 16, where the user may view a list of peer review checklist items for a particular stage. These peer review checklist items may be derived from expert knowledge and best practices accumulated over time and/or generated by project team members at the beginning of the oilfield development project and may include, for example, questions regarding the methodology used, questions about discrepancies in various models, and questions regarding procedures followed. Peer review checklist items that are assigned specifically to the user may be displayed in one area 1602 that also allows the user to answer the various questions, reassign individual questions, enter any comments and/or additional information, and the like. An assign checklists button 1604 allows the user to assign multiple peer review checklist items at once (i.e., a batch assignment). All peer review checklist items for a particular stage may be displayed in another area 1606 along with relevant information therefor (e.g., value, assignment, comments, additional information etc.). Once all of the peer review checklist items are completed, then the status of the checklist items in the stage release area 1512 (see FIG. 15) may be updated accordingly (e.g., completed, etc.).

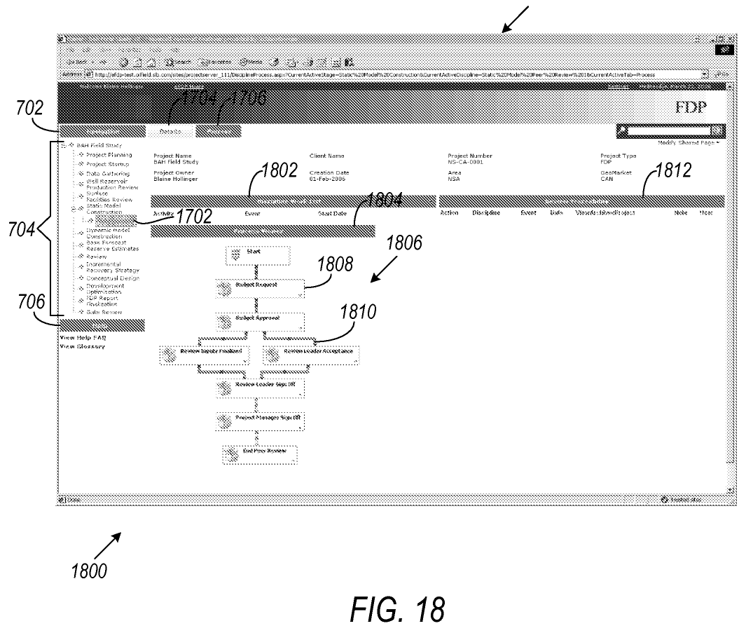

In some embodiments, one or more of the stages 704 may have one or more sub-stages that relate to a particular aspect of the main stage 704. Selecting one of these sub-stages brings up additional information that, as in the case of the main stages 704, is organized and presented in two Web pages, as illustrated in FIGS. 17-18.

Referring now to FIG. 17, the first of the two sub-stage Web pages is a details page 1700 for allowing the user to view and modify specific information for a particular sub-stage. The particular sub-stage selected in this example is a static model peer review sub-stage 1702. A details tab 1704 at the top of the details page 1700 allows the user to quickly select that page. Also present is a process tab 1706 for allowing the user to select a process page (described with respect to FIG. 18) for the particular some stage 1702. In one preferred embodiment, the details page 1700 comprises an objectives area 1708 that allows the user to view, modify, and/or add information regarding one or more objectives of a particular sub-stage. A work list area 1710 may also be present for displaying any checklist items that are specific to this particular sub-stage, along with relevant information therefor. A discipline release area 1712 shows the current stage of the approval workflow.

Because the sub-stage in this example is a peer review sub-stage 1702, an assign review team button 1714 is provided to allow the user to select a review team for the main stage corresponding to the sub-stage. Note that the peer review sub-stages are usually added only when a users selects the plan peer review button 1520, although multiple sub-stages may be created per stage. Inputs from members of the review team may then be uploaded and displayed in a review inputs area 1716. The user may also call one or more meetings of the review team anytime before, during, or after the review by adding one or more agendas to an agenda area 1718. An attendees area 1720 displays the names of various review team members and their statuses with respect to the one or more meetings. Finally, a general discussion area 1722 provides a forum for discussing any issues related to the sub-stage.

Selecting the process tab 1706 takes the user to a process page 1800, illustrated in FIG. 18, where the user may view a detailed workflow for a particular sub-stage (e.g., the static model peer review 1702). In one preferred embodiment, the process stage 1800 comprises a discipline work list area 1802 for displaying various action items to be performed by each discipline (e.g., geophysics, engineering, economics, etc.) involved in the sub-stage. Another area 1804 may be present for displaying a workflow 1806 of the sub-stage. The workflow 1806 may comprise a plurality of work steps 1808 interconnected via workflow lines 1810. Different colors may be used to display the work steps 1808 and workflow lines 1810 based on the statuses thereof. A traceability area 1812 provides tracking information for the various action items to be performed in connection with the sub-stage.

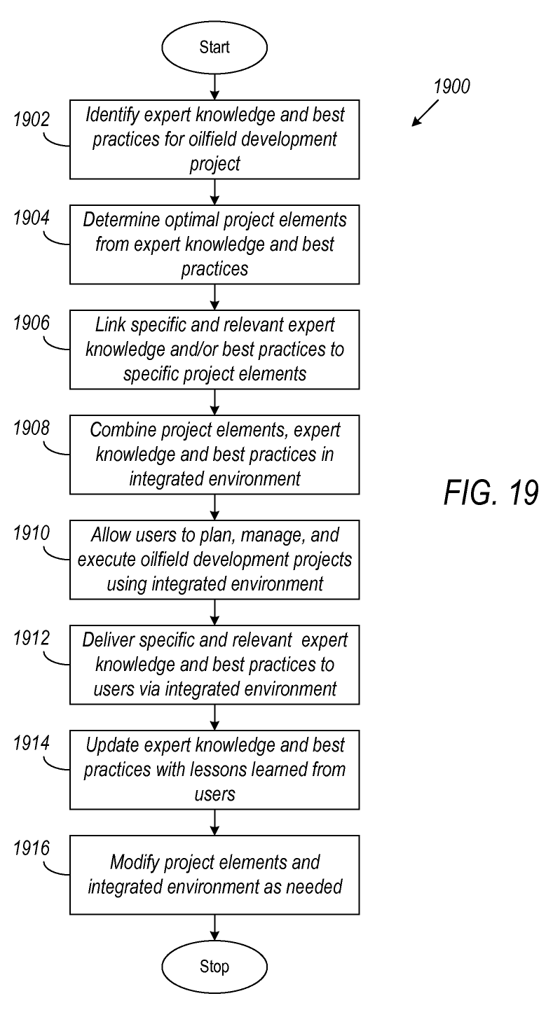

Thus far, specific implementations of the oilfield development project planning and execution tool according to preferred embodiments of the invention have been described. Following now is description of a general method, shown in FIG. 19, that may be used to implement an oilfield project planning and execution tool according to preferred embodiments of the invention. It should be noted that while the method comprises a plurality of individual steps, two or more steps may be combined into a super-step, and a single step may be divided into two or more sub-steps, without departing from the scope of the invention. In addition, one or more steps may be added to or removed from the method by those having ordinary skill in the art without departing from the scope of the invention. Moreover, although the steps of the method are shown and described in a particular order or sequence, other orders or sequences may certainly be used without departing from the scope of the invention.

As can be seen in FIG. 19, a method 1900 for implementing a project planning and execution tool according to preferred embodiments of the invention begins at step 1902, where expert knowledge and best practices for oilfield development projects are obtained (i.e., accumulated, developed, etc.). Such expert knowledge and/or best practices may include one or more of: project element procedures and project element templates. In addition, the expert knowledge and/or the best practices are available from one or more of: a documents database, a knowledge-sharing portal, and a repository of industry literature.

At step 1904, an optimal set of project elements is determined for the oilfield development project based on the expert knowledge and/or best practices identified from previous oilfield development projects. Such project elements may include, for example, project tasks, action items, risk assessments, checklist entries, workflows, workflow tasks, work schedules, and the like.

At step 1906, specific expert knowledge and/or specific best practices are linked with specific project elements, and at step 1908, the project elements are incorporated into an integrated project planning and execution environment. In preferred embodiments, such an integrated project planning and execution environment may be a Web-based environment accessible across different geographical locations and business units.

At step 1910, a user is allowed to plan and execute the project elements using the integrated project planning and execution environment in a manner such that the integrated project planning and execution environment enforce compliance by the user with certain ones of the expert knowledge and/or the best practices. In some preferred embodiments, the user is allowed to plan and execute the project elements by assigning personnel and schedules to the project elements. In some preferred embodiment, enforcing compliance by the user comprises requiring the user to perform one or more of: executing the project elements in a predetermined order, obtaining peer review and approval for certain project elements, and generating one or more predefined reports.

At step 1912, specific expert knowledge and/or specific best practices are delivered to the user upon request, for example, when the user performs one of the project elements. At step 1914, the expert knowledge and/or the best practices may be updated with lessons learned from the user. Finally, at step 1916, the project elements and/or the integrated environment may be modified as needed based on the updates.

Although the foregoing is provided for purposes of illustrating, explaining and describing certain embodiments of the invention in particular detail, modifications and adaptations to the described methods, systems and other embodiments will be apparent to those skilled in the art and may be made without departing from the scope or spirit of the invention.

What is claimed is:

1. A computer-based method for planning and conducting an oilfield development project, comprising:
determining an optimal set of project elements for the oilfield development project based on expert knowledge and/or best practices identified from previous oilfield development projects;
linking specific expert knowledge and/or specific best practices with specific project elements;
presenting the project elements in an integrated project planning and execution environment; and
allowing a user to plan and execute the project elements using the integrated project planning and execution environment, the integrated project planning and execution environment enforcing compliance by the user with certain ones of the expert knowledge and/or the best practices.

2. The computer-based method according to claim 1, further comprising delivering the specific expert knowledge and/or the specific best practices to the user upon request.

3. The computer-based method according to claim 1, further comprising updating the expert knowledge and/or the best practices with lessons learned from the user.

4. The computer-based method according to claim 1, wherein the project elements include one or more of: project tasks, action items, risk assessments, checklist entries, workflows, workflow tasks, and work schedules.

5. The computer-based method according to claim 1, wherein the expert knowledge and/or the best practices include one or more of: project element procedures and project element templates.

6. The computer-based method according to claim 1, wherein the expert knowledge and/or the best practices are available from one or more of: a documents database, a knowledge-sharing portal, and a repository of industry literature.

7. The computer-based method according to claim 1, wherein enforcing compliance by the user comprises requiring the user to perform one or more of: executing the project elements in a predetermined order, obtaining peer review and approval for certain project elements, and generating one or more predefined reports.

8. The computer-based method according to claim 1, wherein allowing the user to plan and execute the project elements comprises allowing the user to assign personnel and schedules to the project elements.

9. The computer-based method according to claim 1, wherein the integrated project planning and execution environment is a Web-based environment accessible across different geographical locations and business units.

10. A computer-based system for planning and conducting an oilfield development project, comprising:
at least one subsystem configured to determine an optimal set of project elements for the oilfield development project based on expert knowledge and/or best practices identified from previous oilfield development projects;
at least one subsystem configured to link specific expert knowledge and/or specific best practices with specific project elements;
at least one subsystem configured to present the project elements in an integrated project planning and execution environment; and
at least one subsystem configured to allow a user to plan and execute the project elements using the integrated project planning and execution environment, the integrated project planning and execution environment enforcing compliance by the user with certain ones of the expert knowledge and/or the best practices.

11. The computer-based system according to claim 10, further comprising at least one subsystem configured to deliver a the specific expert knowledge and/or the specific best practices to the user upon request.

12. The computer-based system according to claim 10, further comprising at least one subsystem configured to update the expert knowledge and/or the best practices with lessons learned from the user.

13. The computer-based system according to claim 10, wherein the project elements include one or more of: project tasks, action items, risk assessments, checklist entries, workflows, workflow tasks, and work schedules.

14. The computer-based system according to claim 10, wherein the expert knowledge and/or the best practices include one or more of: project element procedures and project element templates.

15. The computer-based system according to claim 10, wherein the expert knowledge and/or the best practices are available from one or more of: a documents database, a knowledge-sharing portal, and a repository of industry literature.

16. The computer-based system according to claim 10, wherein the at least one subsystem configured to enforce compliance by the user requires the user to perform one or more of: executing the project elements in a predetermined order, obtaining peer review and approval for certain project elements, and generating one or more predefined reports.

17. The computer-based system according to claim 10, wherein the at least one subsystem configured to allow the user to plan and execute the project elements allows the user to assign personnel and schedules to the project elements.

18. The computer-based system according to claim 10, wherein the integrated project planning and execution environment is a Web-based environment accessible across different geographical locations and business units.

19. A computer-readable storage medium having computer-readable instructions encoded thereon for causing a computer to provide an integrated oilfield development project planning and execution environment, the computer-readable instructions comprising instructions for:
presenting a set of project elements for an oilfield development project in the integrated oilfield development project planning and execution environment, the set of project elements derived based on expert knowledge and/or best practices identified from previous oilfield development projects; and
allowing a user to plan and execute the project elements using the integrated oilfield development project planning and execution environment, the integrated oilfield development project planning and execution environment enforcing compliance by the user with certain ones of the expert knowledge and/or the best practices.

20. The computer-readable storage medium according to claim 19, wherein the computer-readable instructions further comprise instructions for delivering the specific expert knowledge and/or the specific best practices to the user upon request.

21. The computer-readable storage medium according to claim 19, wherein the computer-readable instructions further comprise instructions for updating the expert knowledge and/or the best practices with lessons learned from the user.

22. The computer-readable storage medium according to claim 19, wherein the project elements include one or more of: project tasks, action items, risk assessments, checklist entries, workflows, workflow tasks, and work schedules.

23. The computer-readable storage medium according to claim 19, wherein the expert knowledge and/or the best practices include one or more of: project element procedures and project element templates.

24. The computer-readable storage medium according to claim 19, wherein the expert knowledge and/or the best practices are available from one or more of: a documents database, a knowledge-sharing portal, and a repository of industry literature.

25. The computer-readable storage medium according to claim 19, wherein the computer-readable instructions for enforcing compliance by the user comprises instructions for requiring the user to perform one or more of: executing the project elements in a predetermined order, obtaining peer review and approval for certain project elements, and generating one or more predefined reports.

26. The computer-readable storage medium according to claim 19, wherein the computer-readable instructions for allowing the user to plan and execute the project elements comprises instructions for allowing the user to assign personnel and schedules to the project elements.

27. The computer-readable storage medium according to claim 19, wherein the integrated oilfield development project planning and execution environment is a Web-based environment accessible across different geographical locations and business units.

28. An article of manufacture for use in planning and executing an oilfield development project, comprising:
a processor; and
computer-readable storage medium connected to the processor, the computer-readable storage medium having computer-readable instructions encoded thereon for causing the processor to:
store an optimal set of project elements for the oilfield development project, the project elements based on expert knowledge and/or best practices identified from previous oilfield development projects;
link specific expert knowledge and/or specific best practices with specific project elements;
present the project elements in an integrated project planning and execution environment; and
allow a user to plan and execute the project elements using the integrated project planning and execution environment, the integrated project planning and execution environment enforcing compliance by the user with certain ones of the expert knowledge and/or the best practices.

29. The article of manufacture according to claim 28, wherein the computer-readable instructions further cause the processor to deliver the specific expert knowledge and/or the specific best practices to the user upon request.

30. The article of manufacture according to claim 28 wherein the computer-readable instructions further cause the processor to update the expert knowledge and/or the best practices with lessons learned from the user.

31. The article of manufacture according to claim 28, wherein the project elements include one or more of: project tasks, action items, risk assessments, checklist entries, workflows, workflow tasks, and work schedules.

32. The article of manufacture according to claim 28, wherein the expert knowledge and/or the best practices include one or more of: project element procedures and project element templates.

33. The article of manufacture according to claim 28, wherein the expert knowledge and/or the best practices are available from one or more of: a documents database, a knowledge-sharing portal, and a repository of industry literature.

34. The article of manufacture according to claim 28, wherein the computer-readable instructions cause the processor to enforce compliance by the user by requiring the user to perform one or more of: executing the project elements in a predetermined order, obtaining peer review and approval for certain project elements, and generating one or more predefined reports.

35. The article of manufacture according to claim 28, wherein the computer-readable instructions cause the processor to allow the user to plan and execute the project elements by allowing the user to assign personnel and schedules to the project elements.

36. The article of manufacture according to claim 28, wherein the integrated project planning and execution environment is a Web-based environment accessible across different geographical locations and business units.
